(19) United States
(12) Patent Application Publication
(10) Pub. No.: US 2011/0066880 A1
(43) Pub. Date: Mar. 17, 2011

(54) APPARATUS AND METHOD FOR COMPENSATING FOR SYSTEM MEMORY ERROR

(76) Inventor: Kyungwon Byun, Seoul (KR)

(21) Appl. No.: 12/627,634

(22) Filed: Nov. 30, 2009

(30) Foreign Application Priority Data
Sep. 8, 2009 (KR) 10-2009-0084294

(51) Int. Cl. G06F 11/00; G06F 15/177; G06F 9/00

(52) U.S. Cl. 714/6.11; 713/2; 714/E11.055

(57) ABSTRACT

A method to compensate for a system memory error, including determining whether there is an error in the system memory using a system memory error compensation program; initializing system memory error compensation values during reboot if an error is detected in the system memory; sequentially changing the initialized system memory error compensation values to determine system memory error compensation values that reduce system memory error; and storing the determined system memory error compensation values in a basic input/output system (BIOS) memory.

This application claims the benefit of Korea Patent Application No. 10-2009-0084294 filed on Sep. 8, 2009, which is incorporated herein by reference for all purposes as if fully set forth herein.

### BACKGROUND OF THE INVENTION

1. Field of the Invention

This document relates to an apparatus and method for compensating for a system memory error.

2. Discussion of the Related Art

In general, as shown in FIG. 1, various types of computers such as a laptop computer comprise a processor 10, a device controller 11, a memory controller 12, a basic input/output system (BIOS) memory 13, a hard disk drive (HDD) 14, and a system memory 15.

A nonvolatile memory such as a flash ROM, for example, is used as the BIOS memory 13, and a volatile memory such as a dynamic random access memory (DRAM), for example, is used as the system memory 15.

An operating system (OS) kernel code and a basic input/output system (BIOS) code are stored in the BIOS memory 13, and various application programs such as a video program, an audio program, an integrated drive electronics (IDE) program, and a universal serial bus (USB) program are stored within the BIOS code in the BIOS memory 13.

The device controller 11 reads the OS kernel code and BIOS code stored in the BIOS memory 13, and the memory controller 12 writes the read OS kernel code and BIOS code in the system memory 15.

The processor 10 reads the OS kernel code and BIOS code written in the system memory 15 to perform an operating system (OS) boot process and execute the application programs.

The memory controller 12 writes any other program read from the BIOS memory 13 in the system memory 15.

However, when an error occurs in the system memory 15, it is impossible to normally write the OS kernel code and BIOS code read from the BIOS memory 13 in the system memory 15, and thus a fatal error occurs in the OS boot process.

Moreover, when an error occurs in the system memory upon completion of the OS boot process, it is impossible to normally write any other application program read from the BIOS memory 13 or from the HDD 14, and thus a fatal error occurs during execution of the application program.

Accordingly, a blue screen is still displayed on the computer monitor or a failure (“hang-up”), in which a user's key is not input, occurs, and thus the user should replace the system memory of the computer with a new one.

### SUMMARY OF THE INVENTION

This document provides an apparatus and method for compensating for a system memory error, which can detect an error occurring in a system memory, which is applicable to various types of computers such as desktop and laptop computers and, at the same time, efficiently compensate for the error during reboot.

An aspect of this document is to provide a method to compensate for a system memory error, including determining whether there is an error in the system memory using a system memory error compensation program; initializing system memory error compensation values during reboot if an error is detected in the system memory; sequentially changing the initialized system memory error compensation values to determine system memory error compensation values that reduce system memory error; and storing the determined system memory error compensation values in a basic input/output system (BIOS) memory.

Another aspect of this document is to provide a method to compensate for a system memory error, including storing identification information corresponding to a system memory error in a system memory when a dump file created by the error is stored in a hard disk drive (HDD); initializing system memory error compensation values based on the identification information; sequentially changing the initialized system memory error compensation values to determine system memory error compensation values that reduce system memory error; and storing the determined system memory error compensation values in a basic input/output system (BIOS) memory.

Still another aspect of this document is to provide an apparatus to compensate for a system memory error, including a basic input/output system (BIOS) memory to store application programs; a device controller to control the BIOS memory; a system memory to store the application programs copied from the BIOS memory; a memory controller to control the system memory; and a processor to control the operations of the device controller and the memory controller, wherein the BIOS memory stores a system memory error compensation program and system memory error compensation values, and wherein the system memory error compensation program initializes the system memory error compensation values if an error is detected in the system memory, sequentially changes the initialized system memory error compensation values to determine system memory error compensation values that reduce system memory error, and stores the determined system memory error compensation values in the BIOS memory.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic diagram showing a configuration of a laptop computer in accordance with an exemplary embodiment of the present invention;

FIG. 2 is diagram showing a system memory error compensation program and an error compensation value additionally stored in a BIOS memory in accordance with an exemplary embodiment of the present invention;

FIG. 3 is a block diagram showing a memory controller in accordance with an exemplary embodiments of the present invention;

FIG. 4 is a flowchart illustrating a method for compensating for a system memory error in accordance with an exemplary embodiment of the present invention;

FIGS. 5 to 8 are diagrams illustrating the processes of the method for compensating for a system memory error in accordance with an exemplary embodiment of the present invention;

FIG. 9 is a diagram showing an example in which an initialized system memory error compensation value is changed to a specific value;

FIG. 10 is a flowchart illustrating a method for compensating for a system memory error in accordance with another exemplary embodiment of the present invention; and

FIG. 11 is a diagram showing an example in which a dump file flag is stored in a system memory in accordance with an exemplary embodiment of the present invention.

### DETAILED DESCRIPTION OF THE ILLUSTRATED EMBODIMENTS

The above and other objects, features and advantages of the present invention will be more apparent from the following detailed description taken in conjunction with the accompanying drawings. Hereinafter, exemplary embodiments of the present invention will be described with reference to the accompanying drawings. Like reference numerals designate like elements throughout the specification. In the following description of the embodiment of the present invention, a detailed description of known functions and configurations incorporated herein will be omitted when it may obscure the subject matter of the present invention.

An apparatus and method for compensating for a system memory error in accordance with exemplary embodiments of the present invention are applicable to various types of computer systems such as desktop and laptop computers.

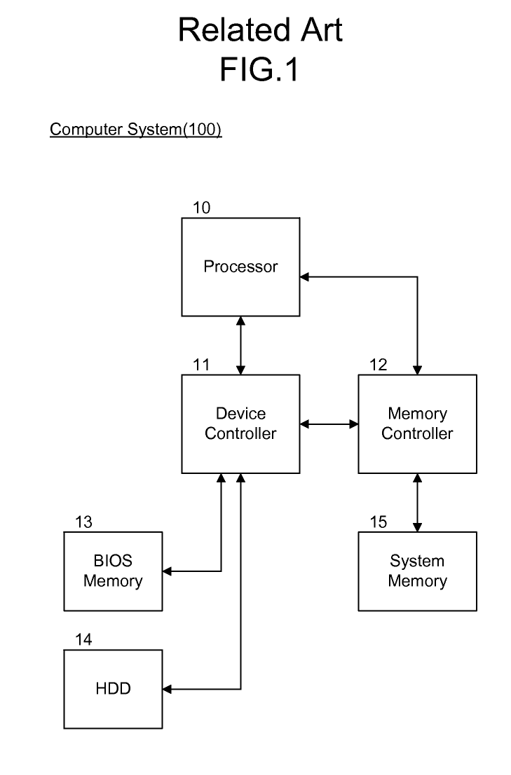

For example, a computer system to which the present invention is applied comprises a processor 10, a device controller 11, a memory controller 12, a basic input/output system (BIOS) memory 13, a hard disk drive (HDD) 14, and a system memory 15 as described above with reference to FIG. 1.

A nonvolatile memory such as a flash ROM is used as the BIOS memory 13, and a volatile memory such as a DRAM is used as the system memory 15. An operating system (OS) kernel code and a basic input/output system (BIOS) code are stored in the BIOS memory 13.

Various application programs such as a video program, an audio program, an integrated drive electronics (IDE) program, and a universal serial bus (USB) program are stored within the BIOS code in the BIOS memory 13.

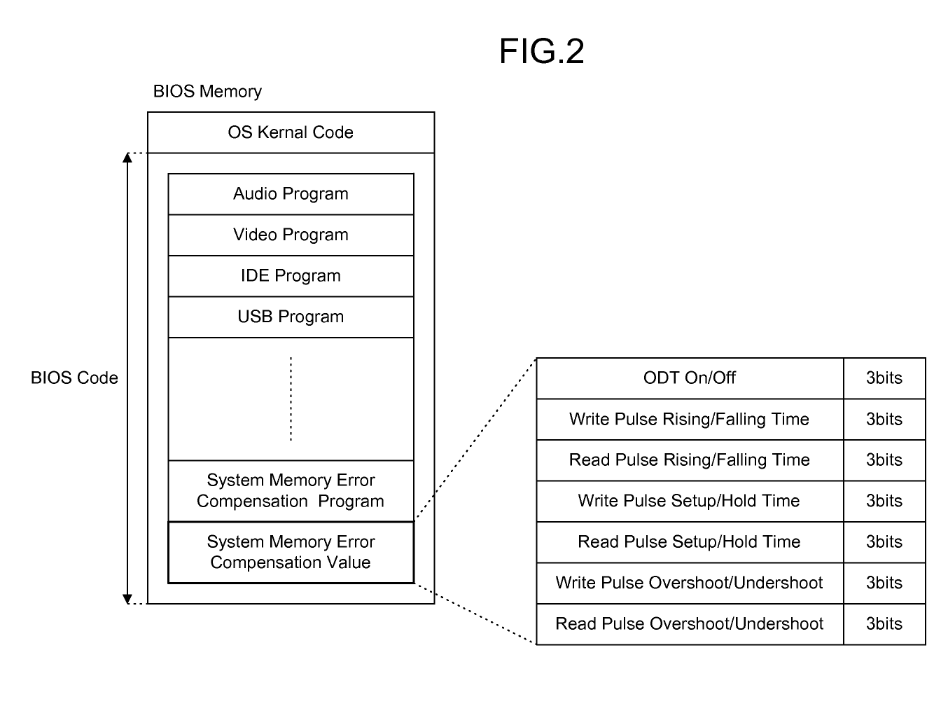

Meanwhile, as shown in FIG. 2, a system memory error compensation program and a system memory error compensation value in accordance with the present invention, for example, are additionally stored in a specific area within the BIOS code of the BIOS memory 13. The system memory error compensation program may be divided into an error detection program and an error test program.

The system memory error compensation value is a multi-step compensation value with respect to various items for compensating for the system memory error and is stored as N-bit values for multi-step compensation for on-die termination on/off control, write pulse rising/falling time, read pulse rising/falling time, write pulse setup/hold time, read pulse rising/falling time, write pulse overshoot/undershoot time, and read pulse overshoot/undershoot time, for example.

When the system memory error compensation value is stored as a 3-bit value, the compensation for each of the compensation items can be performed in a maximum of 8 steps (e.g., 000, 001, 010, 011, 100, 101, 110, and 111).

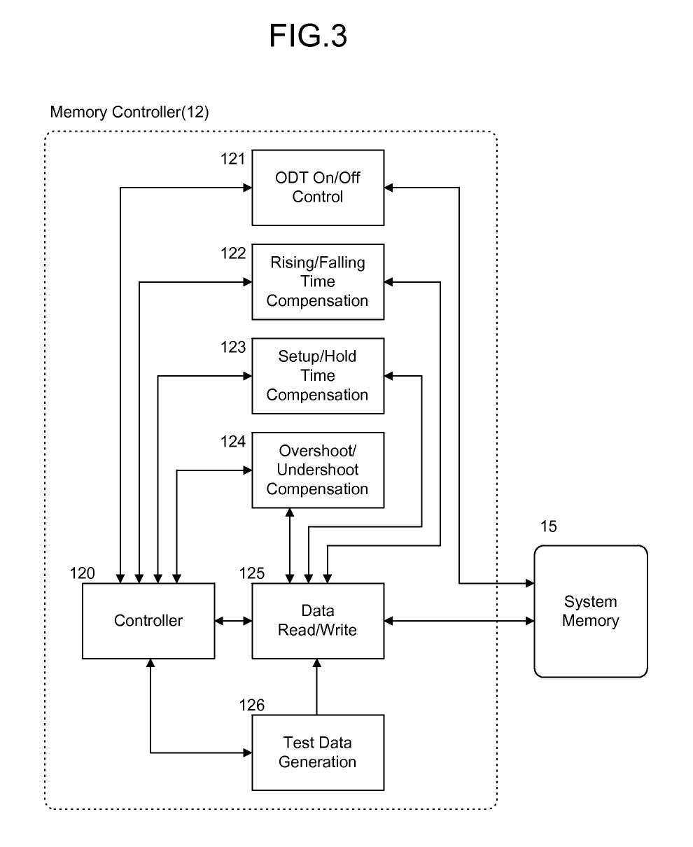

The memory controller 12 may be divided into a plurality of hardware blocks or a plurality of software blocks and, as shown in FIG. 3, may be divided into a plurality of blocks such as a controller 120, an on-die termination (ODT) on/off control block 121, a rising/falling time compensation block 122, a setup/hold compensation block 123, an overshoot/undershoot compensation block 124, a data read/write block 125, and a test data generation block 126.

When the system power is on, the controller 120 copies the system memory error compensation program stored in a specific area of the BIOS memory 13 to the system memory 15 and executes the program.

Then, the controller 120 checks whether there is an error in the system memory 15 and, if an error is detected, compensates for the system memory error by controlling the ODT on/off control block 121, the rising/falling time compensation block 122, the setup/hold compensation block 123, the overshoot/undershoot compensation block 124, the data read/write block 125, and the test data generation block 126, which will be described in detail below.

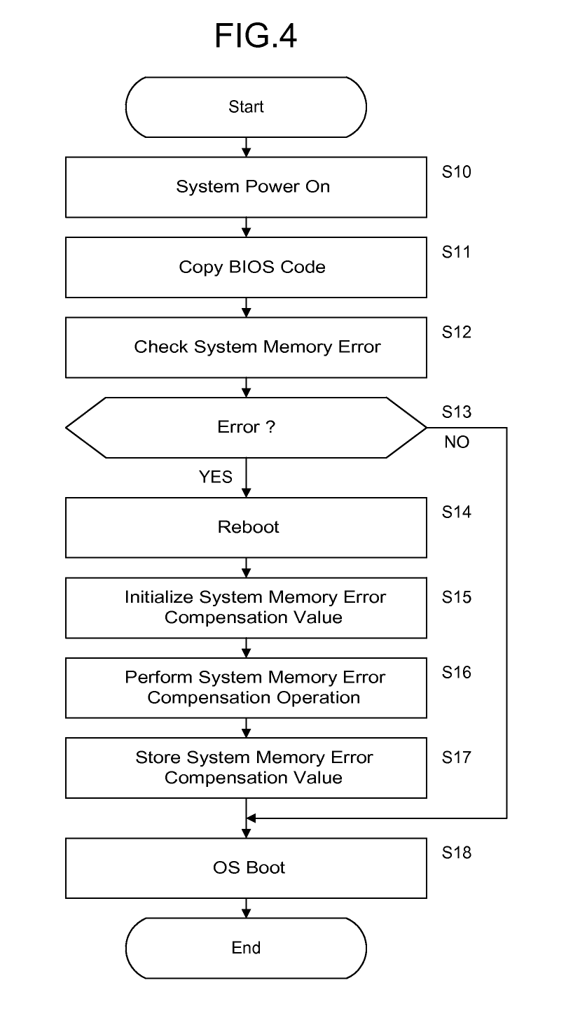

FIG. 4 is a flowchart illustrating a method for compensating for a system memory error in accordance with an exemplary embodiment of the present invention. For example, when the system power is on (S10), the device controller 11 and the memory controller 12 copy the BIOS codes stored in the BIOS memory 13 to the system memory 15 (S11).

The memory controller 12 executes the system memory error compensation program among the copied BIOS codes to check whether there is an error in the system memory 15 (S12).

For example, after performing an operating system (OS) boot process in which the BIOS codes stored in the BIOS memory 13 are copied to the system memory 15, the memory controller 12 executes the system memory error compensation program to transmit a request signal having a predetermined period to the system memory 15 and receive a response signal corresponding to the request signal. The response signal indicates that a specific code is normally written in and read from the system memory 15.

When a response signal is not received from the system memory for a predetermined period of time or more than predetermined number of times, the memory controller 12 determines that there is an error in the system memory 15 (S13).

When the system memory error is detected, a reboot process is performed (S14), and the memory controller 12 performs an interface operation with the device controller 11 to initialize the system memory error compensation values stored in a specific area of the BIOS memory 13 (S15).

For example, the memory controller 12 resets all 3-bit values stored as the system memory error compensation values in the BIOS memory 13 to ‘FFF’, copies the BIOS codes stored in the BIOS memory 13 to the system memory 15, and executes the system memory error compensation program, thus performing a system memory error compensation operation for compensating for the system memory error (S16).

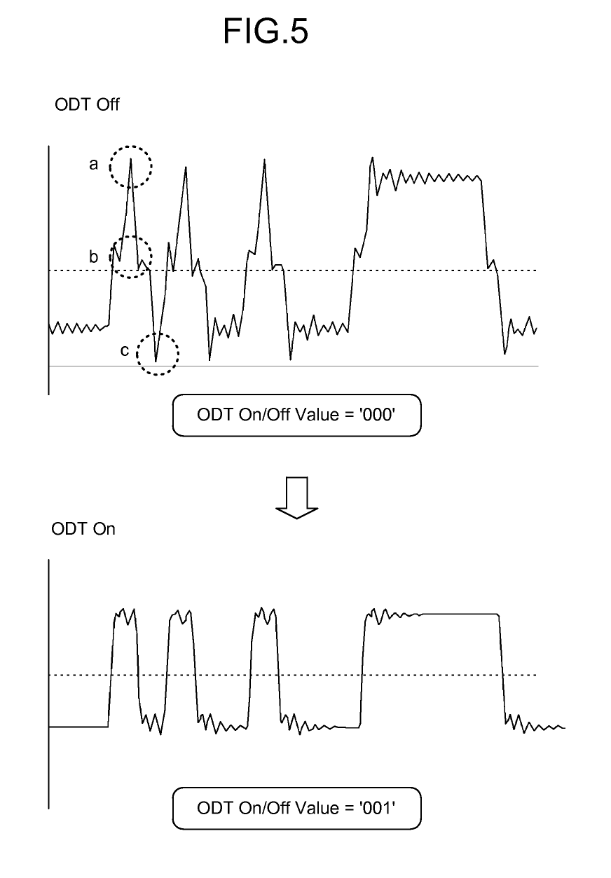

For example, as described above with respect to FIG. 3, the controller 120 changes the initialized ODT on/off control value from ‘FFF’ to ‘000’ such that an ODT on/off control circuit provided in the system memory 15 is in an Off state. Moreover, as shown in FIG. 5, when an overshoot or understood occurs in a write or read pulse and the middle of the pulse is distorted, the controller 120 changes the ODT on/off control value from ‘000’ to ‘001’ such that the ODT on/off control circuit is in an On state in which the overshoot, the undershoot, and the pulse distortion are minimized.

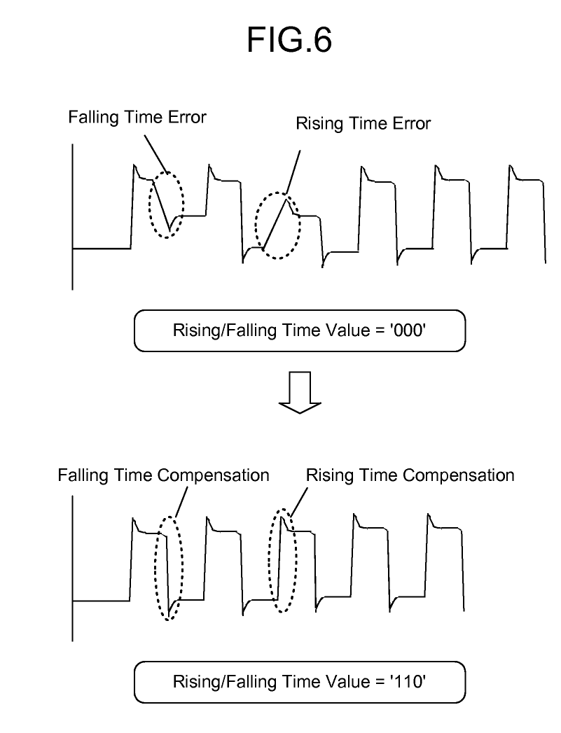

Moreover, as shown in FIG. 6, the controller 120 changes the initialized rising/falling time compensation value of the write pulse from ‘FFF’ to ‘000’ and, if an error that the rising/falling time of the write pulse is distorted occurs, sequentially changes the rising/falling time compensation value of the write pulse from ‘000’ to ‘001’, ‘010’, ‘011’, ‘100’, ‘101’, and ‘110’ to compensate for the error, thus obtaining an optimum rising/falling time.

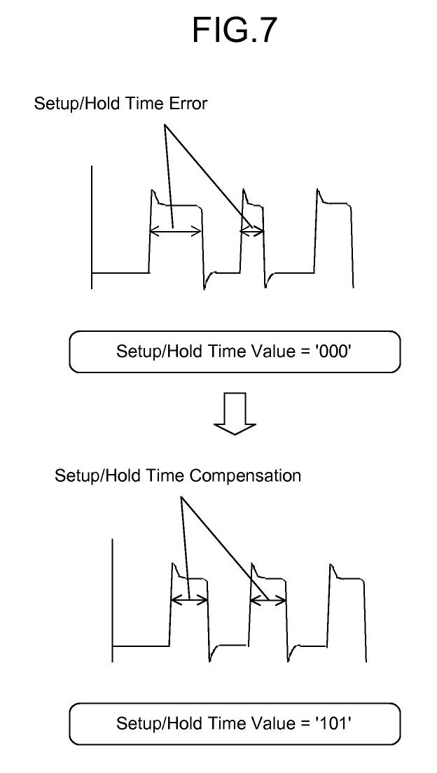

Furthermore, as shown in FIG. 7, the controller 120 changes the initialized setup/hold time compensation value of the write pulse from ‘FFF’ to ‘000’ and, if an error that the setup/hold time of the write pulse is distorted occurs, sequentially changes the setup/hold time compensation value of the write pulse from ‘000’ to ‘00’1, ‘010’, ‘011’, ‘100’, and ‘101’ to compensate for the error, thus obtaining an optimum setup/hold time.

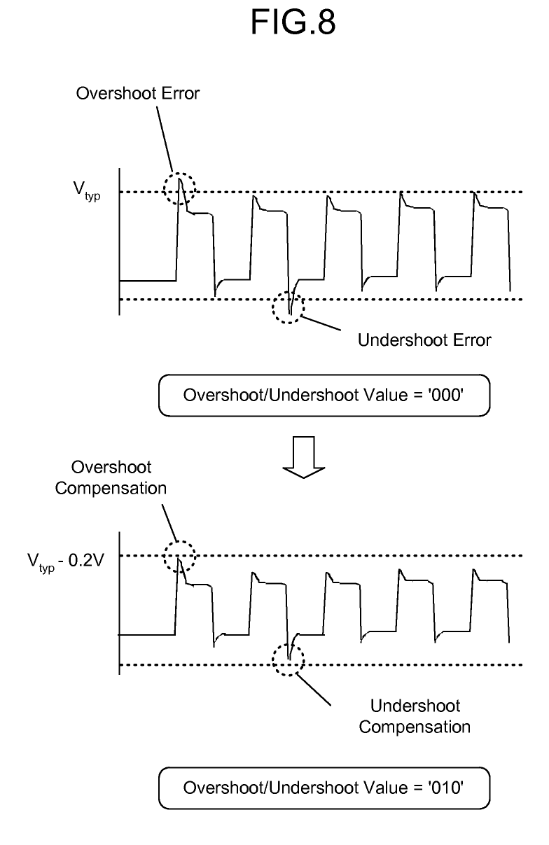

In addition, as shown in FIG. 8, the controller 120 changes the initialized overshoot/undershoot compensation value of the write pulse from ‘FFF’ to ‘000’ and, if an error occurs in the overshoot/undershoot of the write pulse, sequentially changes the overshoot/undershoot compensation value of the write pulse from ‘000’ to ‘001’ and ‘010’ to compensate for the error, thus obtaining an optimum overshoot/undershoot.

Meanwhile, the compensation for the overshoot and undershoot is performed by reducing peak-to-peak voltage of the write pulse from a predetermined reference voltage Vtyp by a predetermined voltage (e.g., 0.1 V).

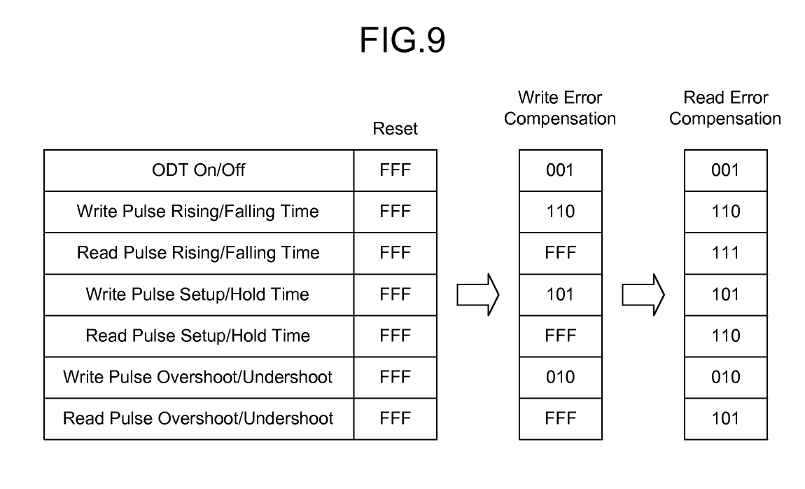

When the system memory error compensation operation for the write pulse is sequentially completed in the above-described manner, the system memory error compensation operation for the read pulse is sequentially performed. Accordingly, as shown in FIG. 9, the system memory error compensation values initialized to ‘FFF’ and stored in the BIOS memory 13 are changed to specific values by the sequential error compensation operation and then stored in the BIOS memory 13.

When the system memory error compensation value is changed to a specific value and stored in the BIOS memory 13 by the above-described process (S17), the memory controller 12 copies the OS kernel code and the BIOS code to the system memory 15, initializes the respective devices, and then performs the OS boot process (S18).

Therefore, it is possible to determine whether there is an error in the system memory before the OS boot process is performed and, at the same time, efficiently compensate for the error during reboot, and thus it is possible to solve the problem that a blue screen is still displayed on a computer monitor or that a failure (“hang-up”), in which a user's key is not input, occurs.

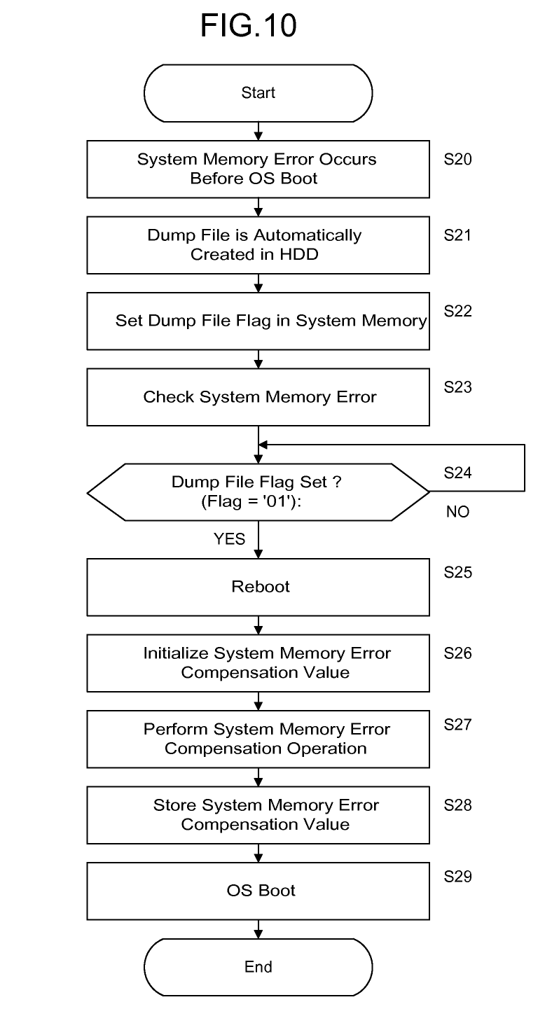

Meanwhile, FIG. 10 is a flowchart illustrating a method for compensating for a system memory error in accordance with another exemplary embodiment of the present invention. For example, as described above with reference to FIG. 4, when the BIOS codes copied to the system memory 15 are uploaded to the processor 10 and the OS boot process is completed, the processor 10 performs an error detection operation, as well known in the art, to determine whether there is an error in the system memory 15.

When an error is detected in the system memory 15, the processor 10 automatically creates a dump file corresponding to the error and stores the dump file in the HDD 14 (S21).

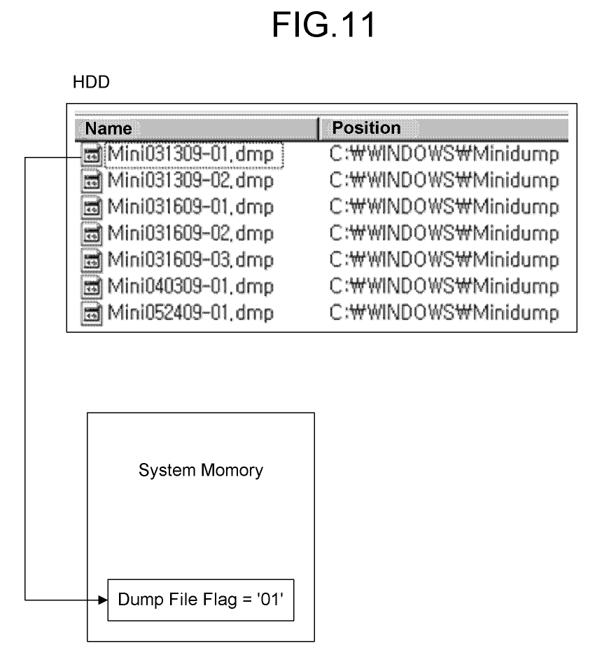

For example, as shown in FIG. 11, when an error is detected in the system memory 15, the processor 10 automatically creates ‘Mini031309-01.dmp’ as a dump file corresponding to the error and stores the dump file in the HDD 14.

That is, the processor 10 sets a dump file flag as identification information indicating that the error is detected in the system memory 15 to ‘01’, for example, in a specific area of the system memory 15 (S22).

Then, the memory controller 12 performs an error detection operation of the system memory to check whether the dump file flag is set to ‘01’ by executing the system memory error compensation program (S23).

When the dump file flag is set to ‘01’ (S24), the memory controller 12 determines that an error occurs in the system memory 15 and performs the reboot process (S25). At this time, the memory controller 12 performs an interface operation with the device controller 11 to initialize the system memory error compensation values stored in a specific area of the BIOS memory 13 (S26).

Then, the memory controller 12 copies the BIOS codes stored in the BIOS memory 13 to the system memory 15 and executes the system memory error compensation program, thus performing the system memory error compensation operation for the system memory error (S27) as described above with reference to FIGS. 5 to 8.

Moreover, as described above with reference to FIG. 9, the initialized system memory error compensation values stored in the BIOS memory 13 are changed to specific values by the error compensation operation and then stored in the BIOS memory 13 (S28).

When the system memory error compensation values are changed to specific values and stored by the above-described operation, the memory controller 12 copies the OS kernel code and the BIOS code to the system memory 15, initializes the respective devices, and then performs the OS boot process (S29).

Therefore, even after the OS boot process is completed, it is possible to determine whether there is an error in the system memory and, at the same time, efficiently compensate for the error during reboot, and thus it is possible to solve the problem that a blue screen is still displayed on a computer monitor or that a failure (“hang-up”), in which a user's key is not input, occurs.

Although exemplary embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

What is claimed:

1. A method to compensate for a system memory error, the method comprising:
determining whether there is an error in the system memory using a system memory error compensation program;
initializing system memory error compensation values during reboot if an error is detected in the system memory;
sequentially changing the initialized system memory error compensation values to determine system memory error compensation values that reduce system memory error; and
storing the determined system memory error compensation values in a basic input/output system (BIOS) memory.

2. The method of claim 1, wherein the system memory error compensation program and the system memory error compensation values are stored in advance in the BIOS memory.

3. The method of claim 1, wherein the system memory error compensation program is copied from the BIOS memory to a system memory during system power-on.

4. The method of claim 1, further comprising copying an operating system (OS) kernel code and a BIOS code to a system memory and performing an operating system (OS) boot process after the determined system memory error compensation values are stored in the BIOS memory.

5. The method of claim 1, wherein the system memory error compensation values are stored as N-bit values to compensate for at least one of on-die termination on/off control, write pulse rising/falling time, read pulse rising/falling time, write pulse setup/hold time, read pulse rising/falling time, write pulse overshoot/undershoot time, and read pulse overshoot/undershoot time.

6. The method of claim 1, wherein the determining of whether there is an error in the system memory includes determining whether a response signal is periodically received from the system memory after the system memory error compensation program is executed.

7. The method of claim 6, further comprising performing an operating system (OS) boot process if a response signal is periodically received from the system memory.

8. The method of claim 1, wherein at least one of on-die termination on/off control, write pulse rising/falling time, read pulse rising/falling time, write pulse setup/hold time, read pulse rising/falling time, write pulse overshoot/undershoot time, and read pulse overshoot/undershoot time is sequentially changed to reduce system memory error.

9. A method to compensate for a system memory error, the method comprising:
storing identification information corresponding to a system memory error in a system memory when a dump file created by the error is stored in a hard disk drive (HDD);
initializing system memory error compensation values based on the identification information;
sequentially changing the initialized system memory error compensation values to determine system memory error compensation values that reduce system memory error; and
storing the determined system memory error compensation values in a basic input/output system (BIOS) memory.

10. The method of claim 9, wherein the system memory error compensation program and the system memory error compensation values are stored in advance in the BIOS memory.

11. The method of claim 9, further comprising copying an operating system (OS) kernel code and a BIOS code to a system memory and performing an operating system (OS) boot process after the determined system memory error compensation values are stored in the BIOS memory.

12. The method of claim 9, wherein the system memory error compensation values are stored as N-bit values to compensate for at least one of on-die termination on/off control, write pulse rising/falling time, read pulse rising/falling time, write pulse setup/hold time, read pulse rising/falling time, write pulse overshoot/undershoot time, and read pulse overshoot/undershoot time.

13. The method of claim 9, wherein the system memory error compensation values are initialized if the identification information stored in the system memory is detected.

14. The method of claim 9, wherein at least one of on-die termination on/off control, write pulse rising/falling time, read pulse rising/falling time, write pulse setup/hold time, read pulse rising/falling time, write pulse overshoot/undershoot time, and read pulse overshoot/undershoot time is sequentially changed to reduce system memory error.

15. An apparatus to compensate for a system memory error, the apparatus comprising:
a basic input/output system (BIOS) memory to store application programs;
a device controller to control the BIOS memory;
a system memory to store the application programs copied from the BIOS memory;
a memory controller to control the system memory; and
a processor to control the operations of the device controller and the memory controller,
wherein the BIOS memory stores a system memory error compensation program and system memory error compensation values, and
wherein the system memory error compensation program initializes the system memory error compensation values if an error is detected in the system memory, sequentially changes the initialized system memory error compensation values to determine system memory error compensation values that reduce system memory error, and stores the determined system memory error compensation values in the BIOS memory.

16. The apparatus of claim 15, wherein the memory controller determines that the error is detected in the system memory when a response signal is not periodically received from the system memory after the system memory error compensation program is executed.

17. The apparatus of claim 15, wherein the memory controller determines that the error is detected when an identification information is detected in the system memory.

18. The apparatus of claim 17, wherein the identification information is stored in the system memory when a dump file is stored in a hard disk drive (HDD) after an operating system (OS) boot.

19. The apparatus of claim 15, wherein the system memory error compensation values are stored as N-bit values to compensate for at least one of on-die termination on/off control, write pulse rising/falling time, read pulse rising/falling time, write pulse setup/hold time, read pulse rising/falling time, write pulse overshoot/undershoot time, and read pulse overshoot/undershoot time.

20. The apparatus of claim 15, wherein at least one of on-die termination on/off control, write pulse rising/falling time, read pulse rising/falling time, write pulse setup/hold time, read pulse rising/falling time, write pulse overshoot/undershoot time, and read pulse overshoot/undershoot time is sequentially changed to reduce system memory error.
